(19) United States
(12) Patent Application Publication
(10) Pub. No.: US 2008/0065715 A1
(43) Pub. Date: Mar. 13, 2008

(54) Client-Server-Based Communications System for the Synchronization of Multimodal data channels

(76) Inventors: Ko-Yu Hsu, Taipei City (TW); Jien-Tsai Chan, Ping-Tung County (TW)

Correspondence Address: NORTH AMERICA INTELLECTUAL PROPERTY CORPORATION, P.O. BOX 506, MERRIFIELD, VA, 22116, US

(21) Appl. No.: 11/467,910

(22) Filed: Aug. 28, 2006

(51) Int. Cl. G06F 15/16

(52) U.S. Cl. 709/203

(57) ABSTRACT

A client-server-based communications system includes: a communications network; an audio user interface, coupled to the communications network, for receiving a user selection command; an interactive voice response (IVR) system, coupled to the communications network, for receiving the user selection command via the communications network and generating a flow request in response to the user selection command; a visual user interface, coupled to the communications network; and a synchronization system, coupled to the IVR system and the communications network, for generating flow control information to control the visual user interface and the IVR system in response to the flow request, thereby synchronizing audio contents played by the audio user interface and visual contents played by the visual user interface.

### BACKGROUND OF THE INVENTION

1. Field of the Invention

The present invention relates to communications systems, more particularly, to a Client-Server-Based Communications System for the Synchronization of Multimodal data channels

2. Description of the Prior Art

Communications technologies have quickly grown become a commonplace application, continually being used and shared by more and more people daily. Recent years have seen tremendous advancements in many such related devices, particularly concerning: wireless communication devices, cellular protocols, and transmission techniques. Commonly used devices can range from basic landline phones, to cellular phones, pagers, and personal desktop assistants (PDAs).

One commonly used application involving phone communication networks relates to interactive voice response (IVR) systems. IVR is a system originally implemented with phone servers to allow speech and/or keypad entry as an input format for directing an IVR user interface menu. For example, movie theaters may offer a dial-in number for the purchase and information of such movie tickets. Upon dialing the movie theater number, the caller may be led to an IVR system, where the caller will be verbally provided with a menu for the selection and purchase of said tickets. The caller can then select and purchase desired tickets according to the choices presented on the IVR menu. Thus verbal or keypad commands triggered by the user will be appropriately acknowledged with a proper response by the IVR system.

IVR systems can be also configured to function with global servers, including internet applications. A user can thus guide their way to a desired webpage or email program through a phone connection to an IVR system having internet accessing capability. Inputs are primarily keypad entries, as well as voice entries that are digitized and converted through recognition software. Therefore, using voice and or keypad entries of the caller, the IVR menu will correctly respond to caller inputs and present the requested internet information through the same phone communications channel.

Multimodal communication formats have also developed as of late, allowing for innovations such as video phone calling and conferencing. Multimodal systems specifically entail the simultaneous transmission and/or reception of two independent communications streams. As an example to the video phone described above, a normal audio stream typically transmitted is additionally complimented with an independent video stream to simultaneously provide a user with both communication streams. 3G is another recent example of a wireless protocol which allows multimodal (audio and video) transmission to wireless devices. Additionally, many users share the benefits of voice over internet protocol (VoIP) to talk to other users either vocally, visually, or both.

However, the multimodal communication apparatus itself requires powerful computing capability to run the conventional multimodal browser to play visual and audio contents. If the automatic speech recognition (ASR) and voice flow control interpreter required are embedded in the same user terminal, a more powerful computing power is demanded. Therefore, a new and improved architecture for implementing the multimodal communication is needed.

### SUMMARY OF THE INVENTION

According to an exemplary embodiment of the present invention, a client-server-based communications system is disclosed. The client-server-based communications system comprising: a communications network; an audio user interface, coupled to the communications network, for receiving a user selection command; an interactive voice response (IVR) system, coupled to the communications network, for receiving the user selection command via the communications network and generating a flow request in response to the user selection command; a visual user interface, coupled to the communications network; and a synchronization system, coupled to the IVR system and the communications network, for generating flow control information to control the visual user interface and the IVR system in response to the flow request, thereby synchronizing audio contents played by the audio user interface and visual contents played by the visual user interface.

According to another exemplary embodiment of the present invention, a client-server-based communications system is disclosed. The client-server-based communication comprising: a communications network; a visual user interface, coupled to the communications network, for receiving a user selection command; an audio user interface, coupled to the communications network; an interactive voice response (IVR) system, coupled to the communications network, for controlling operation of the audio user interface; and a synchronization system, coupled to the IVR system and the communications network, for receiving the user selection command via the communications network, generating flow control information in response to the user selection command, and controlling the visual user interface and the IVR system in response to the flow control information, thereby synchronizing audio contents played by the audio user interface and visual contents played by the visual user interface.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram illustrating a client-server-based communications system according to an embodiment of the present invention.

### DETAILED DESCRIPTION

Certain terms are used throughout the following description and claims to refer to particular system components. As one skilled in the art will appreciate, manufacturers may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” The terms “couple” and “couples” are intended to mean either an indirect or a direct electrical connection. Thus, if a first device couples to a second device, that connection may be through a direct electrical connection, or through an indirect electrical connection via other devices and connections.

Although telecommunications users are able to access other users through bi-directional input and output either in a single mode or channel (video, text, vocal, etc. . . . ), or in a multimodal fashion (audio and video, audio and text, etc. . . . ), current technologies do not allow for a truly synchronized multimodal communications scheme in a client-server fashion, where one communications channel functions in accordance to another. Instead, current methods simply display both channels independently of each other.

The synchronizing of communications streams allows for a more flexible, dynamic and responsive means of communications. Imagine a 3G wireless phone dialing the previously described movie theater IVR system having video transmission and display means. Should a user verbally activate the menu to request movie options, the screen could respond visually to show the possible movie options which were verbally requested. In addition, a synchronized multimodal communications system could continually allow for inputs to be made in both communications streams, and transmit synchronized results in both streams also. If a user confirms selection of a certain movie through the visual interface, the system can confirm the selection in the audio stream, and also show a visual signal on the screen to verify the choice.

The present invention therefore solves the above-described problem by providing a client-server-based communications system. The communications system synchronizes different multimodal communications channels to provide a much more dynamic communications means. Because the different channels can now be interrelated, more user options and inputs can be implemented. This results in further flexibility, clarity, and enjoyment during usage of the communications system.

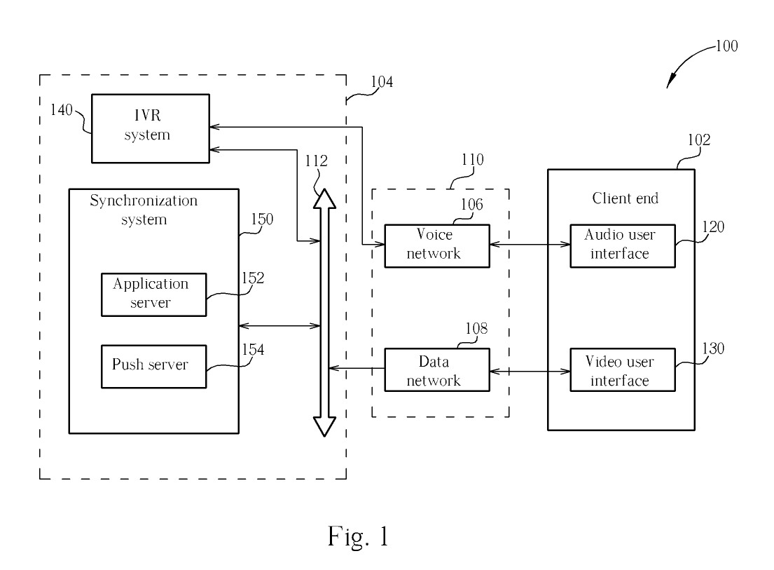

A detailed description of the client-server-based communications system is presented below with reference to the preferred embodiment illustrated in FIG. 1. According to FIG. 1, the client-server-based communications system 100 includes: a client end 102, a server end 104, and a communications network 110. In this embodiment, the communications network 110 contains a voice network 106 for voice communications between the client end 102 and the server end 104, and a data network 108 for data communications between the client end 102 and the server end 104. It should be noted that though the voice network 106 and the data network 108 are shown separately, the present invention is not limited to be implemented using two different networks. For example, in one embodiment of the present invention, both the voice network 106 and the data network 108 could be implemented by Internet.

As shown in FIG. 1, the client end 102 has an audio user interface 120 and a visual user interface 130 coupled to the communications network 110. The server end 104 has an IVR system 140 and a synchronization system 150, where the synchronization system 150 includes an application server 152 and a push server 154. In this embodiment, the communications network 110 is coupled to the IVR system 140 directly, while the communications network 110 is coupled to the synchronization system 150 through a connectivity means 112, such as a bus or a transmission network. Additionally the IVR system 140 and the synchronization system 150 are indirectly coupled to each other via the connectivity means 112.

Please note that the configuration shown in FIG. 1 is for illustrative purposes, and is not meant to be a limitation of the present invention. For example, in one embodiment of the present invention, the application server 152 and the push server 154 are implemented using a single computer; however, in another embodiment, the application server 152 and the push server 154 are implemented using individual computers. Additionally, in one embodiment the audio interface 120 and the visual user interface 130 are both implemented in a single end-user device (e.g., a cellular phone); however, in another embodiment, the audio interface 120 and the visual user interface 130 are implemented in different end-user devices (e.g., a Bluetooth headset serving as the audio interface 120 and a cellular phone display screen serving as the visual user interface 130). These modifications still obey the teachings and principles of the present invention, and as such are also included within the limitations of the present invention

Operation of the client-server-based communications system 100 with reference to the diagram of FIG. 1 is discussed below. A user begins by inputting a selection command through the audio user interface 120. The input mode may be vocal or a keypad entry according to the input/output means of the audio user interface 120. The selection command is then sent to the voice network 106 of the communications network 110, which in turn sends it to the IVR system 140 for processing. The IVR system 140 in turn generates a flow request containing the requested data from the user selection command, and sends the flow request to the synchronization system 150. The synchronization system 150 receives the flow request, and in turn, generates flow control information. This allows the audio content to be played by the audio user interface 120, and visual content displayed by the visual user interface 130 to be synchronized under the control of the synchronization system 150. The audio content is sent to the IVR system 140 by the synchronization system 150, which in turn transmits the audio content to the communications network 110, and is finally received by the audio user interface 120. The visual content is transmitted from the synchronization system 150, to the data network 108 of the communications network 110, and finally received by the visual user interface 130 for display.

The client-server-based communications system 100 therefore generates accompanying visual content for display by the visual user interface 130, even though the selection command is received only from the audio user interface 120. Therefore, the present invention allows display of visual content, through an audio request via the IVR system 140. Additionally, the synchronization system 150 synchronizes the audio content and visual content through the generated flow control information for simultaneous reception by the audio user interface 120 and visual user interface 130 respectively. This allows the user of both interfaces to synchronously listen to and view the multimodal data streams.

The user selection command does not necessarily need to be triggered through the user audio interface 120. Other embodiments can comprise the visual user interface 130 receiving a user selection command from the user. In this embodiment, the synchronization system 150 receives the user selection command through the data network 108 of the communications network 110 and generates the flow control information to synchronize the respective audio/visual content. The audio content played by the audio user interface 120 is received from the voice network 106 of the communications network 110 via the IVR server 140. The visual content displayed by the visual user interface 130 is received from the synchronization system 150. Therefore, accompanying audio content for playback by the audio user interface 120 is provided, even though the selection command is received from the visual user interface 130.

An advantage of the configuration of the client-server-based communications system 100 is that the bulk of the data processing is performed at the server end 104, primarily through any or all of the IVR system 140, the synchronization system 150 and the communications network 110. Typically, these servers possess more processing power than the client end 102 (i.e., the audio user interface 120 or the visual user interface 130 at the user end). This results in more overall processing power to compute user requests, and shorter computational delays for a faster, more seamless communications transfer procedure.

As mentioned above, the synchronization system 150 described above can be further defined into additional components, the application server 154 and the push server 152. The application server 154 acts to generate flow control information and to control the synchronization of audio and visual contents to be played, and also triggers the push server 152 to transmit visual content requested from the user selection command (or flow request in certain embodiments) to the visual user interface 130. It also sends a new voice flow to trigger the IVR system 140 to transmit the audio content requested from the flow control information to the audio user interface 120. The push server 154 is coupled to the communications network 110 and merely acts to push the visual content to the visual interface 130 via the communications network 110. Additionally, the push server 152 can be configured to further reformat the visual content according to the data format supported by the visual user interface 130.

Operation of the client-server-based communications system 100 through specific embodiments is illustrated below by way of examples, with reference to the described figure.

The client-server-based communications system 100 can be applied to a cellular communications network (such as GSM, CDMA, 3G etc. . . . ) where the visual user interface 130 is provided by a cellular phone of the user. The same phone can also provide the audio user interface 120. In other words, the cellular phone here serves as the client end 102 shown in FIG. 1. In this embodiment, the push server 154 includes an internal database to store a plurality of data formats for mapping a respective phone type. When a user selection command is prompted by a user of the phone, it is sent to the communications network 110 and IVR server 140 in a manner as described above. The flow request is received by the synchronization system 150, which in turn generates the flow control information. The push server 154 then selects a specific data format from the internal database according to a phone type of the cellular phone for reformatting the visual content sent to the visual user interface 130. The IVR system 140 then transmits requested audio content information to the audio user interface 120 through the communications network 110, while the push server 154 pushes the visual content to the visual interface 130 also via the communications network 110.

When applied to a 3G cellular communications network, the communications system 100 is implemented as described below. The audio user interface 120 is provided by a 3G SmartPhone, the visual user interface 130 can be a web browser application executed by the same 3G SmartPhone, and the communications network 110 comprises the 3G phone network connected between the audio user interface 120 and the IVR system 140. The 3G GPRS network also connects the synchronization system 150 to the visual user interface 130. In this embodiment, the aforementioned 3G phone network and 3G GPRS network serve as the voice network 106 and the data network 108, respectively.

Additional embodiments of the client-server-based communications system 100 can comprise the audio user interface 120 and the visual user interface 130 both provided through a computer, where the audio user interface 120 is implemented through a VoIP SoftPhone program application. The visual user interface 130 can be implemented by a web browser application, and the communications network 110 is Internet.

Alternatively, the communications system 100 can comprise the audio user interface 120 implemented by a VoIP HardPhone, the visual user interface 130 implemented though the VoIP HardPhone display apparatus, and the communications network 110 being the Internet.

The present invention therefore provides a client-server-based communications system that synchronizes data between different multimodal communications channels. This provides a much more dynamic communications means, as the different channels can now be interrelated, allowing more user options and inputs to be implemented. Further flexibility, clarity, and enjoyment are realized through usage of such a communications system.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A client-server-based communications system, comprising:
a communications network;
an audio user interface, coupled to the communications network, for receiving a user selection command;
an interactive voice response (IVR) system, coupled to the communications network, for receiving the user selection command via the communications network and generating a flow request in response to the user selection command;
a visual user interface, coupled to the communications network; and
a synchronization system, coupled to the IVR system and the communications network, for generating flow control information to control the visual user interface and the IVR system in response to the flow request, thereby synchronizing audio contents played by the audio user interface and visual contents played by the visual user interface.

2. The communications system of claim 1, wherein the synchronization system comprises:
a push server, coupled to the communications network, for pushing the visual contents to the visual interface via the communications network; and
an application server, coupled to the push server, wherein the application server is for generating the flow control information to trigger the push server to transmit the visual contents requested by the flow request to the visual user interface, and to trigger the IVR system to transmit the audio contents requested by the flow control information to the audio user interface.

3. The communications system of claim 2, wherein the push server further reformats the visual contents according to a data format supported by the visual user interface.

4. The communications system of claim 3, wherein the visual user interface is disposed on a cellular phone; the push server includes an internal database storing a plurality of data formats respectively mapped to a plurality of phone types; and the push server selects a specific data format from the internal database according to a phone type of the cellular phone for reformatting the visual contents.

5. The communications system of claim 1, wherein the audio user interface is a telephone, the visual user interface is implemented by a web browser application executed by a computer, and the communications network comprises a public switched telephone network (PSTN) connected between the audio interface telephone and the IVR system and Internet connected between the synchronization system and the visual user interface.

6. The communications system of claim 1, wherein the audio user interface and the visual user interface are both disposed in a computer, the audio user interface is implemented by a VoIP SoftPhone application executed by the computer, the visual user interface is implemented by a web browser application executed by the computer, and the communications network is Internet.

7. The communications system of claim 1, wherein the audio user interface is implemented by a VoIP HardPhone, the visual user interface is implemented by a VoIP HardPhone display screen, and the communications network is Internet.

8. The communications system of claim 1, wherein the audio user interface is implemented by a 3G SmartPhone, the visual user interface is implemented by a web browser application executed by the 3G SmartPhone, and the communications network comprises a 3G phone network connected between the audio user interface and the IVR system and a 3G GPRS network connected between the synchronization system and the visual user interface.

9. A client-server-based communications system, comprising:
a communications network;
a visual user interface, coupled to the communications network, for receiving a user selection command;
an audio user interface, coupled to the communications network;
an interactive voice response (IVR) system, coupled to the communications network, for controlling operation of the audio user interface; and
a synchronization system, coupled to the IVR system and the communications network, for receiving the user selection command via the communications network, generating flow control information in response to the user selection command, and controlling the visual user interface and the IVR system in response to the flow control information, thereby synchronizing audio contents played by the audio user interface and visual contents played by the visual user interface.

10. The communications system of claim 9, wherein the synchronization system comprises:
a push server, coupled to the communications network, for pushing the audio contents to the visual interface via the communications network; and
an application server, coupled to the push server, for receiving the user selection command to generate the flow control information, triggering the push server to transmit the visual contents requested by the flow control information to the visual user interface, and triggering the IVR system to transmit the audio contents requested by the flow control information to the audio user interface.

11. The communications system of claim 10, wherein the push server further reformats the audio contents according to a data format supported by the visual user interface.

12. The communications system of claim 11, wherein the visual user interface is disposed on a cellular phone; the push server includes an internal database storing a plurality of data formats respectively mapped to a plurality of phone types; and the push server selects a specific data format from the internal database according to a phone type of the cellular phone for reformatting the visual contents.

13. The communications system of claim 9, wherein the audio user interface is a telephone, the visual user interface is implemented by a web browser application executed by a computer, and the communications network comprises a public switched telephone network (PSTN) connected between the audio interface telephone and the IVR system and Internet connected between the synchronization system and the visual user interface.

14. The communications system of claim 9, wherein the audio user interface and the visual user interface are both disposed in a computer, the audio user interface is implemented by a VoIP SoftPhone application executed by the computer, the visual user interface is implemented by a web browser application executed by the computer, and the communications network is Internet.

15. The communications system of claim 9, wherein the audio user interface is implemented by a VoIP HardPhone, the visual user interface is implemented by a VoIP HardPhone display screen, and the communications network is Internet.

16. The communications system of claim 9, wherein the audio user interface is implemented by a 3G SmartPhone, the visual user interface is implemented by a web browser application executed by the 3G SmartPhone, and the communications network comprises a 3G phone network connected between the audio user interface and the IVR system and a 3G GPRS network connected between the synchronization system and the visual user interface.
